(19) United States
(12) Patent Application Publication
(10) Pub. No.: US 2026/0161986 A1
(43) Pub. Date: Jun. 11, 2026

(54) METHOD AND APPARATUS FOR GENERATING ENTANGLEMENT OF QUANTUM SYSTEMS

(71) Applicant: PHOTONIC INC., Coquitlam (CA)

(72) Inventors: Evan MACQUARRIE, Burnaby (CA); Evan MEYER-SCOTT, Edmonton (CA)

(21) Appl. No.: 18/980,490

(22) Filed: Dec. 13, 2024

Related U.S. Application Data
(60) Provisional application No. 63/612,241, filed on Dec. 19, 2023.

(51) Int. Cl. G06N 10/40

(52) U.S. Cl. CPC G06N 10/40

(57) ABSTRACT

Methods and apparatus for causing quantum entanglement of first and second quantum systems having first and second non-degenerate ground states involve mapping the first ground state to a coherent superposition of the first and second ground states while mapping the second ground state to the second ground state by applying first optical pulses to each of the first and second quantum systems. The method monitors for any resulting photons in a first window. A projective measurement is performed on the first and second quantum systems by applying second optical pulses to each of the first and second quantum systems and monitoring for any resulting photons in a second window. The method assesses heralding conditions for the first and second windows to determine whether the first and second quantum systems are entangled. The method does not require initialization of the quantum systems.

### CROSS-REFERENCE TO RELATED APPLICATION

This application claims the benefit under 35 U.S.C. § 119 of U.S. application No. 63/612,241 filed 19 Dec. 2023 and entitled METHOD AND APPARATUS FOR GENERATING ENTANGLEMENT OF QUANTUM SYSTEMS which is hereby incorporated herein by reference for all purposes.

### FIELD

This invention relates to the field of quantum mechanics. Embodiments of the invention provide methods and systems for generating entanglement of quantum systems.

### BACKGROUND

Quantum systems have corresponding quantum states. The result of a measurement on a quantum system depends on the quantum state of the quantum system. For example, where the quantum system is a particle, such as an electron that has an intrinsic spin of ½ a measurement of the spin of the quantum system along any axis will yield a result of +½ corresponding to a quantum state of |↑>|↑> or “spin up” or a result of −½ corresponding to a quantum state of |↓>|↓> or “spin down”.

A characteristic of quantum systems is that quantum systems can exist in superpositions of quantum states. For example, an electron may have a quantum state |ψ [symbol] given by: |ψ [symbol] =α|↑ [symbol] +β|↓ [symbol] . Measurements made on such an electron will yield the result +½ or −½ with a probability that depends on the values of α and β.

Another characteristic of quantum systems is that quantum states of two quantum systems may correspond to an entangled state (it is common to describe this by saying that the quantum systems are entangled). When two quantum systems are entangled the results of measurements on the two quantum systems are correlated. For example, two electrons may have an entangled state which forces measurements of the spins of the two electrons relative to a particular axis to yield the same result. Such a state may be represented as: |φ≥α|↑↑ [symbol] |φ=α|↑↑ [symbol] +β|↓↓ [symbol] .

Quantum entanglement may be exploited in various useful ways. For example, entanglement may be used in protocols for: quantum teleportation; quantum error correction, measurement based computing, and so on. As a result, quantum entanglement has become a key resource for quantum informatics and quantum communication. Consequently, there is a need for efficient ways to create quantum entanglement.

Some quantum entanglement protocols are “heralded”. A heralded entanglement protocol included an output that provides an indication that the protocol has succeeded in generating quantum entanglement.

Some quantum entanglement protocols are “probabilistic”. A probabilistic entanglement protocol has the property that the probability that entanglement will be created when the protocol is executed is less than 100% even under the most optimum circumstances.

An example quantum entanglement protocol that is both heralded and probabilistic is described in: Barrett S D, Kok P (2005) Efficient high-fidelity quantum computation using matter qubits and linear optics. Phys Rev A 71:060310. https://doi.org/10.1103/PhysRevA.71.060310. Available at https://link.aps.org/doi/10.1103/PhysRevA.71.060310.

The Barrett and Kok protocol generates entanglement of remote spin quantum systems by steps that include initializing the quantum states of the remote spin quantum systems and temporarily encoding the initial quantum states of the remote spin quantum systems in respective photon states. The photon states are caused to interfere with one another at a beam splitter. The photon states are detected by photon detectors at outputs of the beam splitter. Certain patterns of photon detections (“clicks”) project the remote spins into an entangled state and herald the entanglement.

A disadvantage of the Barret and Kok protocol is that it requires initialization of the quantum systems that are to be entangled. This can be a problem because initialization may take a significant amount of time. Furthermore, since the protocol is probabilistic on average the protocol will need to be executed more than once before entanglement is heralded. Thus, the Barret and Kok protocol can be undesirably slow.

There is a need for new ways to generate entangled states on demand. There is a particular need for new heralded protocols for generating entangled states rapidly.

### SUMMARY

This invention has a number of aspects. These include, without limitation: methods for generating entanglement of quantum systems; apparatus for generating entanglement of quantum systems; and control systems for apparatus for generating entanglement of quantum systems.

One aspect of the invention provides a method for causing quantum entanglement of a first quantum system and a second quantum system. E of the first and second quantum systems has first and second non-degenerate ground states, an excited state, a first optical transition from the first ground state to the excited state and a second optical transition from the excited state to the second ground state. The method comprises a) for each of the first and second quantum systems, mapping the first ground state to a coherent superposition of the first and second ground states while mapping the second ground state to the second ground state by applying a first optical pulse to each of the first and second quantum systems, the first optical pulses having a wavelength matching the first optical transition and being applied to the first and second optical systems with a timing such that any photons resulting from application of the first optical pulses to the first and second quantum systems will be present substantially simultaneously for detection; b) in a first window following application of the first optical pulses, monitoring to detect photons resulting from application of the first optical pulses to the first and second quantum systems; c) making a projective measurement of the first and second quantum systems; and, d) determining whether or not the first and second quantum systems are entangled based on a first heralding condition for any photons detected in the first window and a second heralding condition for any photons detected in a second window associated with the projective measurement.

In some embodiments, making the projective measurement comprises c1) applying a second optical pulse to each of the first and second quantum systems, the second optical pulses being applied to the first and second optical systems with a timing such so that photons resulting from application of the second optical pulses to the first and second quantum systems will be present substantially simultaneously for detection; and c2) in the second window following application of the second optical pulses, monitoring to detect photons resulting from application of the second optical pulses to the first and second quantum systems.

In some embodiments, if the first and second heralding conditions are not both satisfied, repeating steps a) through d) without first initializing either of the first and second quantum systems.

In some embodiments, the first and second heralding conditions each require detection of one photon.

In some embodiments the method comprises, until determining that the first and second quantum systems are entangled, proceeding from one iteration of the method to the next without initializing either of the first and second quantum systems.

In some embodiments the method comprises, prior to step a) of a first iteration of the method, initializing the first and second quantum systems into a combined state that maximizes a probability that the first iteration of the method will succeed at generating entanglement of the first and second quantum systems.

In some embodiments the method comprises iterating the method a plurality of times until determining that the first and second quantum systems are entangled, wherein the method comprises, after a majority of the iterations, proceeding from one iteration of the method to a next iteration of the method without initializing either of the first and second quantum systems.

In some embodiments, the first optical transition is a cross transition.

In some embodiments, the second optical transition is a vertical transition.

In some embodiments, the first and second quantum systems are in a mixed state prior to step a).

In some embodiments, the heralding conditions reject all but one component of the mixed state.

In some embodiments, the heralding conditions reject all components of the mixed state except for |↓↓ [symbol] .

In some embodiments, whenever the heralding conditions are not satisfied in an iteration of the method, the combined quantum state of the first and second quantum systems is different after the iteration of the method than the combined quantum state of the first and second quantum systems immediately before the iteration.

In some embodiments, each of the first and second quantum systems is an electron spin associated with a luminescence centre. In some embodiments the luminescence centre is a T centre.

In some embodiments, the projective measurement is a Bell state measurement.

In some embodiments, the method comprises, between steps c) and d), mapping the first ground state to the second ground state and mapping the second ground state to the first ground state.

In some embodiments, mapping the first ground state to the second ground state and mapping the second ground state to the first ground state comprises applying a microwave pulse to the first and second quantum systems.

In some embodiments, at least the first quantum system is associated with a respective client quantum system and a timing of the mapping the first ground state to the second ground state and mapping the second ground state to the first ground state is selected to uncouple a phase of a quantum state of the client quantum system accumulated over one iteration of the method from the quantum state of the first quantum system during the iteration of the method.

In some embodiments, the method comprises altering one or more iterations of the method based on measurement results obtained in one or more prior iterations of the method.

In some embodiments, the method comprises in response to detecting two photons in either of the first window and the second window of one iteration of the method, flipping spins of the first and second quantum systems prior to step a) of a next iteration of the method.

Another aspect of the invention provides a method for causing entanglement of a first quantum system and a second quantum system. Each of the first and second quantum systems has first and second non-degenerate ground states, an excited state, a first optical transition from the first ground state to the excited state and a second optical transition from the excited state to the second ground state. The method comprises: a) applying an optical π/2 pulse to each of the first and second quantum systems, the optical π/2 pulses having a wavelength that matches the first optical transition and being applied to the first and second quantum systems with a timing such that any photons resulting from application of the optical π/2 pulses to the first and second quantum systems will be present substantially simultaneously for detection; b) in a first window following application of the optical π/2 pulses, monitoring to detect photons resulting from application of the optical π/2 pulses to the first and second quantum systems; c) applying a microwave π pulse to each of the first and second quantum systems; and d) applying an optical π pulse to each of the first and second quantum systems, the optical π pulses having a wavelength that matches the second optical transition and being applied to the first and second quantum systems with a timing such so that photons resulting from application of the optical π pulses to the first and second quantum systems will be present substantially simultaneously at the detector; e) in a second window following application of the optical π pulses, monitoring to detect photons resulting from application of the optical π pulses to the first and second quantum systems; f) determining whether a heralding condition for the first window and a heralding condition for the second window are satisfied; and, g) if the heralding condition for the first window and the heralding condition for the second window are not both satisfied, repeating steps a) through f) without initializing either of the first and second quantum systems.

Another aspect of the invention provides a method for causing entanglement of a first quantum system and a second quantum system. Each of the first and second quantum systems has first and second non-degenerate ground states, an excited state, a first optical transition from the first ground state to the excited state and a second optical transition from the excited state to the second ground state. The method comprises applying first optical stimulation to each of the first and second quantum systems. The first optical stimulation maps the first ground state to a superposition of the first ground state and the second ground state and maps the second ground state to the second ground state. The first optical stimulation is applied to the first and second quantum systems with a timing such that any photons resulting from application of the first optical stimulation to the first and second quantum systems will be present substantially simultaneously for detection. In a first window following application of the first optical stimulation the method monitors to detect photons resulting from application of the first optical stimulation to the first and second quantum systems. In an optional step the method then maps the first ground state to the second ground state and maps the second ground state to the first ground state. The method applies second optical stimulation to each of the first and second quantum systems. The second optical stimulation maps one of the ground states to itself with the emission of a photon and maps the other one of the ground states to itself without the emission of a photon. The second optical stimulation is applied to the first and second quantum systems with a timing such so that any photons resulting from application of the second optical stimulation to the first and second quantum systems will be present substantially simultaneously at the detector. In a second window following application of the second optical stimulation the method monitors to detect photons resulting from application of the second optical stimulation to the first and second quantum systems. The method repeats the above steps in successive iterations until an iteration in which the heralding condition for the first window and a heralding condition for the second window are both satisfied. For at least some iterations of the method, the first and second quantum systems are not initialized between the end of the iteration and the next iteration. In some embodiments the first and second quantum systems are not initialized between successive iterations of the method.

Another aspect of the invention provides apparatus having any new and inventive feature, combination of features, or sub-combination of features as described herein.

Another aspect of the invention provides methods having any new and inventive steps, acts, combination of steps and/or acts or sub-combination of steps and/or acts as described herein.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1 is a flow chart illustrating a method according to an example embodiment of the invention.

FIG. 1A is an energy level diagram for a quantum system of a type that may be used in the method of FIG. 1.

FIG. 2 is an energy level diagram for a T centre which is a type of quantum system that may be used in the method of FIG. 1.

FIG. 2A is a drawing that illustrates the atomic structure of a T centre.

FIG. 3 is a graph showing probability of success of sequential iterations of the method of FIG. 1.

FIG. 4 is a graph which includes curves which illustrate evolution of the probabilities associated with components of a mixed state of two quantum systems for sequential iterations of the method of FIG. 1.

FIG. 5 is a graph showing estimated entanglement fidelity and probability of success of an iteration of the method of FIG. 1 as a function of branching ratio for transitions from an excited state to ground state of quantum systems used in the method of FIG. 1.

FIG. 6 is a schematic illustration of an example apparatus that may be used in performance of the method of FIG. 1.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

### Example Method

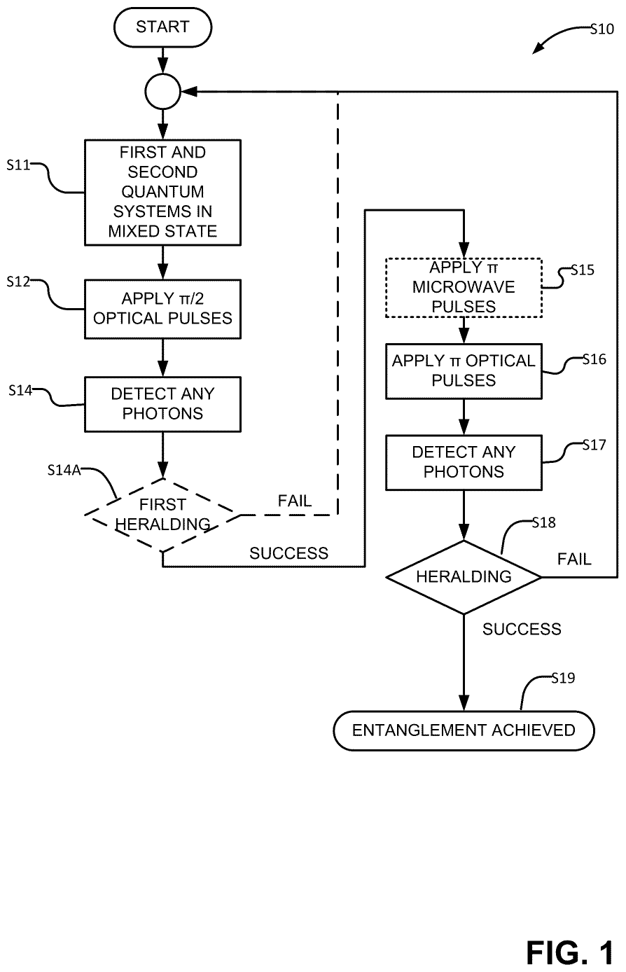

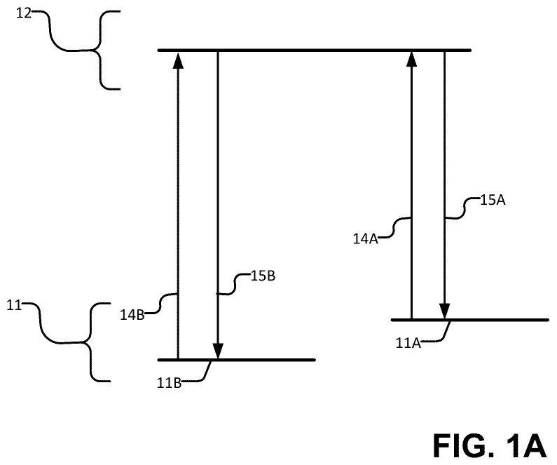

FIG. 1 is a flow chart that illustrates steps in a method S10 for generating entanglement of two quantum systems. FIG. 1A is a drawing that illustrates example energy levels and transitions for quantum systems that may be used in the method of FIG. 1.

Quantum systems according to the energy level diagram of FIG. 1A have a ground state 11 and an excited state 12. Ground state 11 is split into energy levels 11A and 11B. Energy levels 11A and 11B are non-degenerate (i.e. there is an energy difference between energy levels 11A and 11B). In some embodiments the quantum systems have intrinsic spins and energy levels 11A and 11B correspond to spin up and spin down quantum states respectively. The arrangement of transitions in FIG. 1A is an example of a “lambda” transition structure.

A transition 14A exists from ground state level 11A to excited state 12. A transition 14B exists from ground state level 11B to excited state 12. A transition 15A exists from excited state 12 to ground state level 11A. A transition 15B exists from excited state 12 to ground state level 11B. The probabilities of transitions 15A and 15B are not equal. In some embodiments one of transitions 15A and 15B is forbidden. In some embodiments a probability that excited state 12 will decay by way of one of transitions 15A and 15B is significantly less than a probability that the excited state will decay by way of the other one of transitions 15A and 15B (e.g. at least 30% less likely). In some embodiments one of transitions 15A and 15B is prohibited.

Transitions 14A, 14B, 15A and 15B are optical transitions (i.e. the transitions involve absorbing or emitting an optical photon—i.e. a photon that has a wavelength in the range of far infrared to ultraviolet—1000 μm to 100 nm).

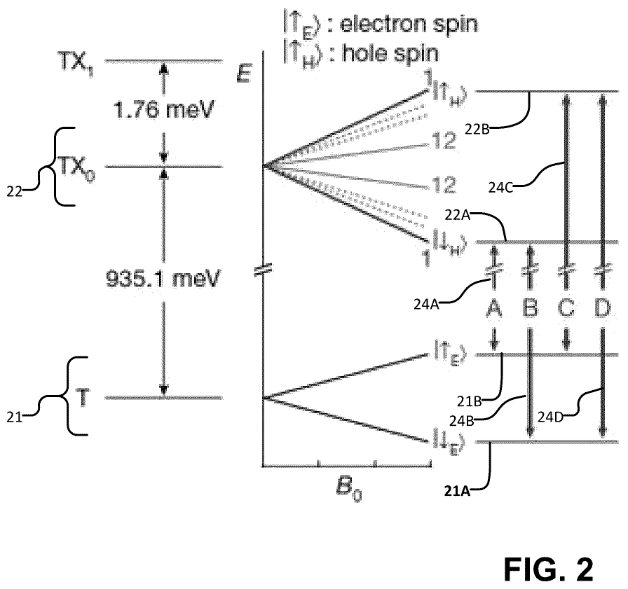

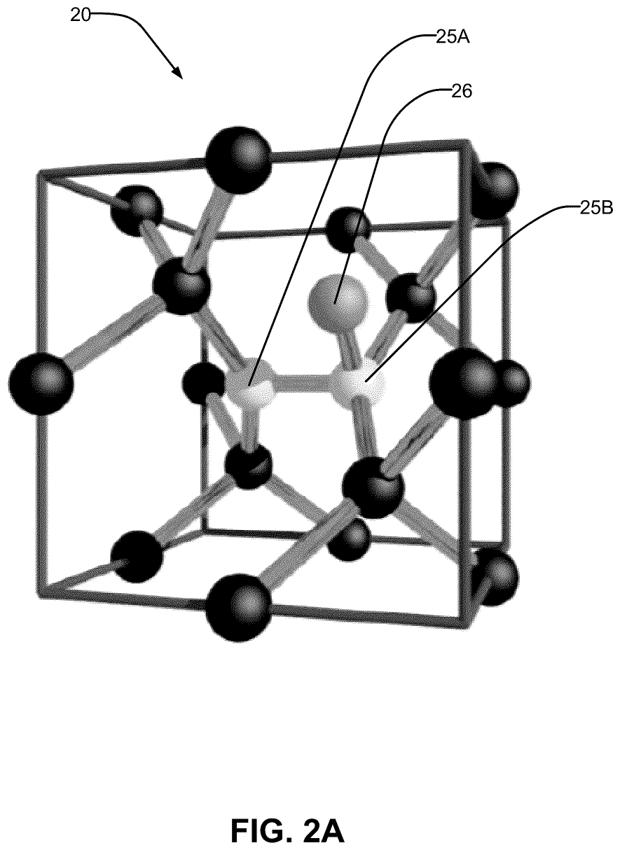

Some embodiments of the present technology use quantum systems in which excited state 12 is split into plural non-degenerate energy levels (see FIG. 2 for an example of this).

The first and second quantum systems may be distributed (i.e. spaced apart so that there is no direct interaction between the first and second quantum systems). In some embodiments the first and second quantum systems are separated by large distances.

At block S11 first and second quantum systems are collectively in a mixed quantum state. A mixed quantum state is a state described by a density operator. Where a state of a quantum system can be represented by the sum of a finite number of discrete basis states (e.g. a spin up state and a spin down state for a quantum system that has intrinsic spin ½) the density operator can be represented as a density matrix. The density matrix for a particular mixed state w may be written as:

$$\vert ψ 〉 〈 ψ \vert = {\sum }_{n = 1 , N} {p}_{n} \vert n 〉 〈 n \vert$$

where N is the number of basis states, n is an index, pₙpₙ is the probability for each basis state (with Σₙ pₙ=1 Σₙ pₙ=1) and |n [symbol] |n [symbol] are the basis states. A mixed quantum state may be a pure quantum state but is not necessarily a pure quantum state.

The precise makeup of the mixed quantum state at the start of method S10 does not matter. In general, the first and second quantum systems will be found to be in a mixed state without any need for initializing the quantum states of the first and second quantum systems. For example, each of the first and second quantum systems may have a respective probability of being found in a spin up state upon measurement and a respective probability of being in a spin down state upon measurement. The mixed state does not need to be maximally mixed. Partially mixed states may be used.

At block S12 optical (coherent) π/2 pulses are applied to each of the first and second quantum systems. The π/2 pulses have a wavelength that matches a first optical transition which is one of transitions 14A and 14B of the first and second quantum systems. In a subsequent block, optical pulses may be applied that have a wavelength that matches a second optical transition which is the other one of transitions 14A and 14B of the first and second quantum systems.

The π/2 pulses have a duration selected to cause a state of the first and second quantum systems, as represented by a vector in the Bloch sphere, to be rotated by π/2 radians about a selected axis. Applying the π/2 pulses to the first and second quantum systems introduces coherence between basis states of the systems. In other words, exciting the first and second quantum systems in this manner causes a transformation or mapping of the quantum state of the first and second quantum systems from an initially uninitialized ground state to a coherent superposition of the ground state and the excited state.

The π/2 pulses are delivered at times selected such that any photons emitted by the first and second quantum systems will arrive substantially simultaneously at a photon detector. Here, “substantially simultaneously” means that any photons emitted by the first and second quantum system as a result of application of the π/2 pulses in block S12 will be present simultaneously at the detector such that photon states generated at the first and second quantum systems can interfere with one another at the detector. In some embodiments, “substantially simultaneously” is achieved when optical pulses 11A and 11C arrive at a BSA at times that are 2 ns or less apart. In some embodiments the time of flight for photons from each of the first and second quantum systems to reach the detector is substantially equal such that photons originating from the first and second quantum systems as a result of the application of the same optical π/2 pulse or simultaneous optical pulses to both of the first and second quantum systems will arrive at the detector substantially simultaneously.

Applying the π/2 pulse to the first and second quantum systems can result in emission of a photon by the first and/or second quantum system. A photon is emitted when a quantum system transitions to the excited state (e.g. by transition 14A or 14B) and returns to the ground state. The photons emitted by the first and second quantum systems are indistinguishable when they interact in the BSA.

The monitoring in block S14 is done in a way that does not acquire information about which quantum system emitted any detected photon. The monitoring determines whether 0, 1 or 2 photons are detected within a first detection window. The monitoring may, for example be performed using a Bell state analyzer (“BSA”).

Block S14 monitors a detector for photons being emitted from the first and second quantum systems during the first detection window. The first detection window is selected to be long enough to have a sufficient probability of detecting photons that may be emitted from the first and second quantum systems as a result of the application of the π/2 pulses in block S12.

The first detection window is also selected to be short enough that the probability of the detector falsely indicating detection of photons (“dark counts”) is suitably low. If the detector used in block S14 has a higher rate of dark counts then a shorter first detection window may be used than in cases where the detector has a lower rate of dark counts.

The length of the first detection window may be based on a decay constant, ττ for the excited state of the first and second quantum systems. In some embodiments the length of the first detection window is at least 1.5 ττ or at least 2τ. In an example embodiment the length of the first detection window is approximately τ3τ.

Block S15, which is optional, applies a microwave π pulses to each of the first and second quantum systems. If optional block S15 is omitted method S10 is modified as discussed below.

Block S16 applies optical π pulses to each of the first and second quantum systems. The optical π pulse has a wavelength that matches the second optical transition (e.g. optical transition 14B if the first optical pulse applied in block S12 had a wavelength that matched optical transition 14A). As with block S12, application of the optical π pulses to the first and second quantum systems is coordinated so that any photons emitted by the first and second quantum systems will arrive substantially simultaneously at a detector (which may be the same detector that is used in block S14).

Block S17 monitors a detector for photons being emitted from the first and second quantum systems during a second detection window as a result of the optical π pulses of block S16. The second detection window may have the same length as the first detection window although it is not mandatory that the first and second detection windows have the same lengths. The second detection window may be selected using the criteria described above for the first detection window. As with block S14, the detection in block S17 does not determine which of the first and second quantum systems was the source of any individual photon.

Block S18 determines whether or not heralding conditions are satisfied. The heralding conditions require a detection of one and only one photon in each of blocks S14 and S17. If the heralding conditions are satisfied then the first and second quantum systems are entangled as indicated at block S19. If the heralding conditions are not satisfied then method S10 returns to block S11 for another iteration of method S10.

It is not necessary to initialize either of the first and second quantum systems before performing another iteration of method S10 or at the start of method S10. In this context, “initializing” a quantum system means taking steps to place the quantum system into a specified state. For example, a quantum system having the energy levels of FIG. 1A may be initialized to be in state 11B by optically pumping on transition 14A for a sufficient time (as long as optical transition 15A is not forbidden).

In some embodiments method S17 includes an optional block S14A that determines whether block S14 detected a single photon. If not the heralding conditions cannot be satisfied. In this case, block S14A may return to block S11.

Because method S10 does not require initialization of quantum systems, each iteration of method S10 may be completed in a shorter time than would be required if initialization were required in each iteration. Initialization of an electron spin by optical pumping including time for the system to stabilize after optical pumping may, for example, take about 100 ns to 100 μs. Each iteration of an entanglement protocol that requires initialization will require time in addition to the time required for initialization of the quantum systems. By comparison, in some embodiments, each iteration of method S10 may have a duration in the range of about 250 ns to about 5 μs.

FIG. 2 is an energy level diagram for a T-centre, which is an example of a type of quantum system that may be used for each of the first and second quantum systems in method S10. FIG. 2A shows the structure of a T centre 20.

A T center is a location where a silicon atom in a silicon crystal has been replaced by two carbon atoms 25A and 25B and a hydrogen atom 26 is bonded to carbon atom 25B. Carbon atom 25A has one unpaired electron. The spin state of the unpaired electron of carbon atom 25A may be used as a quantum system in method S10.

The T centre has a ground state 21. With the application of a magnetic field B₀ the ground state is split into levels 21A and 21B. Level 21A corresponds to an unpaired electron spin of the T centre being spin up (oriented parallel with the magnetic field). Level 21B corresponds to the electron spin being spin down (antiparallel with the magnetic field). The spin up state has higher energy than the spin down state because electrons have a g value that is negative.

The T centre has excited states which correspond to the existence of bound exciton states. The two lowest energy bound exciton states are TX0 and TX1. In the presence of the magnetic field, energy level 22 corresponding to TX0 is split into levels 22A and 22B which correspond to hole spin up and hole spin down. The energies of levels 22A and 22B depend on the orientation of the T centre. As a result of the splitting of ground state 21 and excited state TX0, the optical transition between TX0 and the ground state T is split into four spin-dependent optical transitions 24A, 24B, 24C and 24D. An excitation of transition 24D may be followed by a decay though transition 24C. An excitation of transition 24B may be followed by a decay through transition 24A.

### Analysis of Example Method

The following example describes how quantum states of two quantum systems which have energy levels as shown in FIG. 2 evolve as method S10 is performed. In this example optical transitions 24D and 24C are used as the first and second optical transitions. Optical transitions 24B and 24A may be used as the first and second optical transitions in the alternative.

In the following example, each of the first and second quantum systems is initially in a fully mixed state (i.e. the mixed state includes every basis state with equal probability). For the case of an individual quantum state made up of a spin ½ system the fully mixed state for the quantum system can be expressed by the density matrix

$$\frac{1}{2} \vert ↓ 〉 〈 ↓ \vert + \frac{1}{2} \vert ↑ 〉 〈 ↑ \vert \cdot \frac{1}{2} \vert ↓ 〉 〈 ↓ \vert + \frac{1}{2} \vert ↑ 〉 〈 ↑ \vert .$$

In the following example, there are no photon losses, measurements are perfect and excited level 22B decays to ground state level 21B (by transition 24C) with 100% probability. None of these assumptions are required for successful performance of method S10. However these assumptions clarify the following explanation of method S10.

The following example uses the notation: |S, N [symbol] |S, N [symbol] where S identifies a state and Nis a number of photons. For a single spin ½ quantum system S can have the value ↑ or ↓. For two spin ½ quantum systems S can have one of the values: ↑↑, ↑↓, ↓↑ and ↓↓. For a single quantum system N can have the value 0 or 1. For two quantum systems N can have the value 0, 1 or 2.

In this example, the first and second quantum systems (in this example, are each an electron spin of a T centre) are each initially in a fully mixed state. A fully mixed state includes all possible quantum states of the quantum system with equal probability. The fully mixed state for this example is characterized by the following density matrix:

$$\frac{1}{2} ( \vert ↑ 〉 〈 ↑ \vert + \vert ↓ 〉 〈 ↓ \vert ) \frac{1}{2} ( \vert ↑ 〉 〈 ↑ \vert + \vert ↓ 〉 〈 ↓ \vert ) . \qquad ( 1 )$$

In this case, the combined (mixed) state of the first and second quantum systems is also fully mixed. The fully mixed state of the first and second quantum systems can be written as the following density matrix which has four components:

$$\vert ψ 〉 〈 ψ \vert = \frac{1}{4} ( \vert ↑ ↑ 〉 〈 ↑ ↑ \vert + \vert ↑ ↓ 〉 〈 ↑ ↓ \vert + \vert ↓ ↑ 〉 〈 ↓ ↑ \vert + \vert ↓ ↓ 〉 〈 ↓ ↓ \vert ) \qquad ( 2 )$$

$$\vert ψ 〉 〈 ψ \vert = \frac{1}{4} ( \vert ↑ ↑ 〉 〈 ↑ ↑ \vert + \vert ↑ ↓ 〉 〈 ↑ ↓ \vert + \vert ↓ ↑ 〉 〈 ↓ ↑ \vert + \vert ↓ ↓ 〉 〈 ↓ ↓ \vert ) .$$

The probabilities associated with the four components of the mixed state density matrix are modified by the performance of blocks of method S10. It should be emphasized that method S10 does not require quantum systems to be initially in a fully mixed state. A fully mixed state is a convenient example initial state because it includes all possible components. The effect of method S10 on each of these components can be followed as discussed below.

Application of the π/2 pulse at block S12 causes, for each of the first and second quantum systems, the mapping: |↑ [symbol] [symbol] |↑,0 [symbol] . This is because the π/2 pulse excites transition 24D which does not involve the state |↑ [symbol] and so a quantum system that is initially in the state |↑ [symbol] |↑ [symbol] remains in the state |↑ [symbol] after application of the π/2 pulse.

Application of the π/2 pulse at block S12 also causes, for each of the first and second quantum systems, the mapping |↓ [symbol] [symbol] (|↑,1 [symbol] +|↓,0 [symbol] )/\sqrt{2}|↓ [symbol] [symbol] (|↑,1 [symbol] +|↓,0 [symbol] )/\sqrt{2}. This is because application of the π/2 pulse has an equal probability of exciting the state |↓ [symbol] to energy level 22B which then decays to energy level 21B which corresponds to the state |↑ [symbol] |↑ [symbol] with the emission of one photon and leaving the state |↓ [symbol] |↓ [symbol] unaltered, with the emission of no photons.

The above mappings determine how application of the π/2 pulse at block S12 transforms each of the four components of the density matrix of Eqn. 2 that characterizes the combined (mixed) state of the first and second quantum systems. Similar mappings for each step of method S10 may be applied to find a density matrix that characterizes the mixed combined state of the first and second quantum systems at the successful conclusion of method S10.

The |↑↑ [symbol] [symbol] ↑↑∥↑↑ [symbol] [symbol] ↑↑| component of Eqn. (2) does not contribute to the eventual state of the combined system at the successful conclusion of method S10 where success is determined by the evaluation of the heralding conditions. This is because, after the application of the π/2 pulse of block S12, this component becomes |↑↑,0 [symbol] [symbol] ↑↑,0∥↑↑,0 [symbol] [symbol] ↑↑,0|. This involves emission of 0 photons in block S14 and therefore the heralding condition for block S14 which required detection of one photon cannot be satisfied. Therefore, this component is rejected (cannot contribute to the state of the combined system at the successful conclusion of method S10).

The |↑↓ [symbol] [symbol] ↑↓∥↑↓ [symbol] [symbol] ↑↓| component of Eqn. (2) also does not contribute to the eventual state of the combined system at the successful conclusion of method S10. This is because, after the application of the π/2 pulse of block S12, this component becomes (|↑↓,0 [symbol] +|↑↑,1 [symbol] )(|↑↓,0)+|↑↑,1 [symbol] )/2. The heralding condition on the photon detection at block S14 rejects the state |↑↓,0 [symbol] [symbol] ↑↓,0∥↑↓,0 [symbol] [symbol] ↑↓,0| (which involves zero photons to be detected at block S14). The remaining transformed component |↑↑,1 [symbol] [symbol] ↑↑,1∥↑↑,1 [symbol] [symbol] ↑↑,1| is transformed by the microwave π pulse of block S15 to |↓↓ [symbol] [symbol] ↓↓∥↓↓ [symbol] [symbol] ↓↓|. The optical π pulse of block S16 at the wavelength of optical transition 24C maps this state onto |↓↓,0 [symbol] [symbol] ↓↓,0∥↓↓,0 [symbol] [symbol] ↓↓,0| which is rejected by the heralding condition for the detection of block S17 because there are no photons to be detected.

The |↓↑ [symbol] [symbol] ↓↑∥↓↑ [symbol] [symbol] ↓↑| component of Eqn. 2 also does not contribute to the eventual state of the combined system at the successful conclusion of method S10. This is because, after the application of the π/2 pulse of block S12, this component becomes (|↓↑,0 [symbol] +|↑↑,1 [symbol] )(|↓↑,0 [symbol] +|↑↑,1 [symbol] )/2. The heralding condition on the photon detection at block S14 rejects the component |↓↑,0 [symbol] [symbol] ↓↑,0∥↓↑,0 [symbol] [symbol] ↓↑,0| (which involves zero photons to be detected at block S14) leaving the component |↑↑,1 [symbol] [symbol] ↑↑,1∥↑↑,1 [symbol] [symbol] ↑↑,1|. The microwave π pulse at block S15 further transforms this component to |↓↓ [symbol] [symbol] ↓↓|·|↓↓ [symbol] [symbol] ↓↓|. The optical π pulse of block S16 that has a wavelength matching optical transition 24C transforms this component to |↓↓,0 [symbol] [symbol] ↓↓,0∥↓↓,0 [symbol] [symbol] ↓↓,0| which is rejected by the heralding condition for the detection of block S17 because there are no photons to be detected.

It can be seen that the heralding conditions of method S10 cause it to be the case that none of the components |↑↑ [symbol] [symbol] ↑↑|,|↑↓ [symbol] [symbol] ↑↓|, and |↓↑ [symbol] [symbol] ↓↑| from the mixed state of Eqn. 2 can generate a successful heralding condition at both of blocks S14 and S17. Thus, none of these three components will contribute to the combined state of the two quantum systems at the successful conclusion of method S10.

The component |↓↓ [symbol] [symbol] ↓↓∥↓↓ [symbol] [symbol] ↓↓| from Eqn. 2 is mapped by the optical π/2 pulse of block S12 to:

$$\frac{1}{4} ( \vert ↓ ↓ , 0 〉 + \vert ↓ ↑ , 1 〉 + \vert ↑ ↓ , 1 〉 + \vert ↑ ↑ , 2 〉 ) ( 〈 ↓ ↓ , 0 \vert + 〈 ↓ ↑ , 1 \vert + 〈 ↑ ↓ , 1 \vert + 〈 ↑ ↑ , 2 \vert ) \frac{1}{4} ( \vert ↓ ↓ , 0 〉 + \vert ↓ ↑ , 1 〉 + \vert ↑ ↓ , 1 〉 + \vert ↑ ↑ , 2 〉 ) ( 〈 ↓ ↓ , 0 \vert + 〈 ↓ ↑ , 1 \vert + 〈 ↑ ↓ , 1 \vert + 〈 ↑ ↑ , 2 \vert ) .$$

The component |↓↓,0 [symbol] [symbol] ↓↓,0| is rejected by the heralding condition on block S14 because there are no photons to be detected for this component and the heralding conditions require detection of a single photon at block S14. In the ideal case of no photon loss, the component |↑↑,2 [symbol] [symbol] ↑↑,2| is also rejected by the heralding condition on block S14 because the detection of two photons does not satisfy the requirement that a single photon be detected in block S14.

If the heralding condition of block S14 is satisfied then, after block S14, the density matrix is as follows (because the two components that cannot satisfy the heralding condition for block S14 are rejected):

$$\frac{1}{2} ( \vert ↓ ↑ 〉 + \vert ↑ ↓ 〉 ) ( 〈 ↓ ↑ \vert + 〈 ↑ ↓ \vert ) .$$

The microwave π pulse of block S15 transforms this density matrix to:

$$\frac{1}{2} ( \vert ↑ ↓ 〉 + \vert ↓ ↑ 〉 ) ( 〈 ↑ ↓ \vert + 〈 ↓ ↑ \vert ) .$$

The optical π pulse of block S16 acting on optical transition 24C maps this density matrix to:

$$\frac{1}{2} ( \vert ↑ ↓ , 1 〉 + \vert ↓ ↑ , 1 〉 ) ( 〈 ↑ ↓ , 1 \vert + 〈 ↓ ↑ , 1 \vert ) ,$$

which corresponds to an entangled state in which spins of the first and second quantum systems are anti-correlated. This state is equivalent to the Bell states |Ψ [symbol] =|↑↓ [symbol] ±|↓↑Ψ [symbol] =|↑↓ [symbol] ±|↓↑ [symbol] . The plus sign corresponds to the case where the same photon detector of the BSA detects the single photon in each of blocks S14 and S17. The minus sign corresponds to the case where different photon detectors of the BSA detect the photon in blocks S14 and S17 respectively.

Executing any individual iteration of method S10 may fail to result in heralded entanglement of the first and second quantum systems. Such failure may, for example result from photon loss (such that the heralding condition is not satisfied) and/or due to the initial state of the first and/or second quantum systems being such that the execution of method S10 does not project the combined state of the first and second quantum systems onto a desired entangled state.

The discussion above shows that only a starting state that includes the density matrix component |↓↓ [symbol] [symbol] ↓↓| can lead to successful heralding of entanglement. However, the quantum state of the first and second quantum systems is changed after each iteration of method S10.

Performing an iteration of method S10 where the first and second quantum systems are initially in the state |↑↑ [symbol] |↑↑ [symbol] which corresponds to the density matrix |↑↑ [symbol] [symbol] ↑↑∥↑↑ [symbol] [symbol] ↑↑| leaves the density matrix for the first and second quantum systems as follows:

$$\vert ↓ , ↓ , 0 , 0 〉 〈 ↓ , ↓ , 0 , 0 \vert$$

where the first and second arrows indicate spin states of the first and second quantum systems respectively and the first and second numbers following the arrows indicate the number of photons detected in blocks S14 and S17 respectively.

Performing an iteration of method S10 where the first and second quantum systems are initially in the state |↑↓ [symbol] which corresponds to the density matrix |↑↓ [symbol] [symbol] ↑↓| leaves the density matrix for the first and second quantum systems as follows:

$$\frac{1}{2} ( \vert ↓ , ↓ , 1 , 0 〉 〈 ↓ , ↓ , 1 , 0 \vert + \vert ↓ , ↑ , 0 , 1 〉 〈 ↓ , ↑ , 0 , 1 \vert ) .$$

Performing an iteration of method S10 where the first and second quantum systems are initially in the state |↑↓ [symbol] |↓↑ [symbol] which corresponds to the density matrix |↑↓ [symbol] [symbol] ↑↓∥↓↑ [symbol] [symbol] ↓↑| leaves the density matrix for the first and second quantum systems as follows:

$$\frac{1}{2} ( \vert ↓ , ↓ , 1 , 0 〉 〈 ↓ , ↓ , 1 , 0 \vert + \vert ↓ , ↑ , 0 , 1 〉 〈 ↓ , ↑ , 0 , 1 \vert ) \frac{1}{2} ( \vert ↓ , ↓ , 1 , 0 〉 〈 ↓ , ↓ , 1 , 0 \vert + \vert ↑ , ↓ , 0 , 1 〉 〈 ↑ , ↓ , 0 , 1 \vert ) .$$

Performing an iteration of method S10 where the first and second quantum systems are initially in the state |↓↓ [symbol] which corresponds to the density matrix |↓↑ [symbol] [symbol] ↓↑∥↓↓ [symbol] [symbol] | leaves the density matrix for the first and second quantum systems as follows:

$$\frac{1}{2} ( \vert ↓ , ↓ , 1 , 0 〉 〈 ↓ , ↓ , 1 , 0 \vert + \vert ↑ , ↓ , 0 , 1 〉 〈 ↑ , ↓ , 0 , 1 \vert ) \frac{1}{4} ( \vert ↓ , ↓ , 2 , 0 〉 〈 ↓ , ↓ , 2 , 0 \vert + \vert ↑ , ↓ , 1 , 1 〉 〈 ↑ , ↓ , 1 , 1 \vert + \vert ↓ , ↑ , 1 , 1 〉 〈 ↓ , ↑ , 1 , 1 \vert + \vert ↑ , ↑ , 0 , 0 〉 〈 ↑ , ↑ , 0 , 0 \vert ) .$$

As a result of the microwave π-pulse at block S15, after one iteration of method S10, each of these ending states (which can be an initial state for the next iteration) is a mixed state that has a significant probability for the component |↓↓ [symbol] [symbol] ↓↓| so subsequent applications of the protocol will have some probability of success.

### Evolution of Mixed States

As an example of how the combined mixed quantum state of quantum systems may change as a result of iterations of method S10, the first and second quantum systems may have the mixed state of Eqn. 2 when a first iteration of method S10 begins. In the absence of any additional knowledge (e.g. knowledge obtained through photon detections at blocks S14 and S17) at the end of a first iteration of method S10 one entanglement attempt, the system is in the mixed state:

$$\vert {Ψ}_{1} 〉 = \frac{1}{16} \vert ↑ ↑ 〉 〈 ↑ ↑ \vert + \frac{3}{16} \vert ↓ ↑ 〉 〈 ↓ ↑ \vert + \frac{3}{16} \vert ↑ ↓ 〉 〈 ↑ ↓ \vert + \frac{9}{16} \vert ↓ ↓ 〉 〈 ↓ ↓ \vert$$

A second iteration of method S10 would then have a probability of success of 9η²/32. If the second iteration also fails, the mixed state becomes:

$$\vert {Ψ}_{2} 〉 = \frac{9}{64} \vert ↑ ↑ 〉 〈 ↑ ↑ \vert + \frac{15}{64} \vert ↓ ↑ 〉 〈 ↓ ↑ \vert + \frac{15}{64} \vert ↑ ↓ 〉 〈 ↑ ↓ \vert + \frac{25}{64} \vert ↓ ↓ 〉 〈 ↓ ↓ \vert$$

A third iteration of method S10 consequently has a 25η²/128 probability of success.

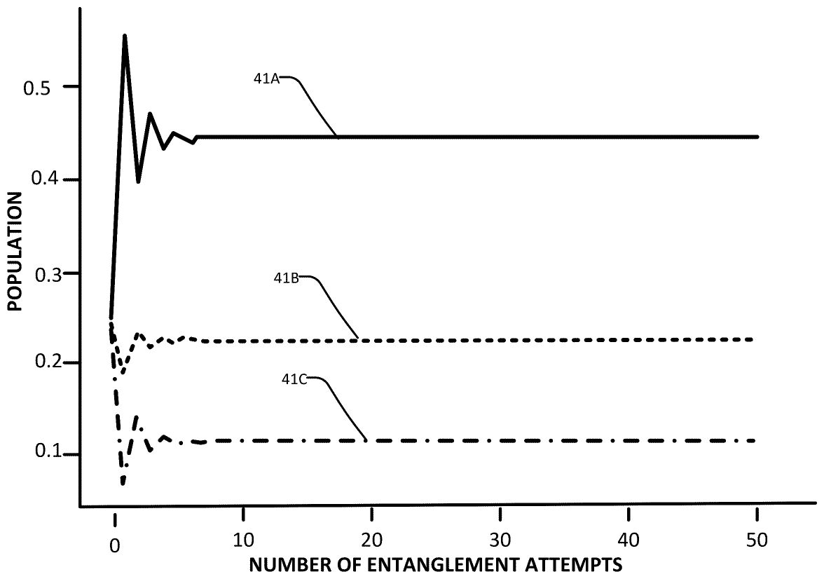

FIGS. 4A to 4D are plots which show the probability of each of the components of Eqn. 2 in the mixed state at the conclusion of an iteration of method S10 as a function of a number of iterations of method S10 where the starting state is the mixed state shown in Eqn. 2.

### Probability of Successful Heralded Entanglement

An important figure of merit for any probabilistic entanglement protocol is the probability that an entangled state will be successfully heralded when the protocol is executed. From the above discussion it can be seen that an iteration of method S10 may generate entanglement of the first and second quantum systems from an initial mixed state for which the density matrix includes the component |↓↓ [symbol] [symbol] ↓↓∥ [symbol] [symbol] ↓↓|. In the limit of perfect photon transmission and detection the likelihood that the first iteration of method S10 will successfully herald entanglement of the first and second quantum systems is the probability associated with the component |↓↓ [symbol] [symbol] ↓↓∥↓↓ [symbol] [symbol] ↓↓| times 50%. Where the initial density matrix is provided by Eqn. 2 the probability of success is ¼×½=⅛. In some embodiments prior to the start of method S10 the quantum systems to be entangled are initialized to the state |↓↓ [symbol] [symbol] ↓↓∥↓↓ [symbol] [symbol] ↓↓|, which maximizes the likelihood of success of the first iteration of method S10. In such embodiments, subsequent iterations may proceed without initialization as described elsewhere herein.

In a real case where not all photons are successfully detected the success probability for an iteration of method S10 that commences with the mixed state of Eqn. (2) is η²/8 where η is photon transmittance. In the ideal case where there are no photon losses and every photon emitted from the first/second quantum system is successfully detected η=1. This probability is lower than the success probability per iteration for some other entanglement protocols. However, in some embodiments the disadvantage of lower success probability per iteration is more than compensated for by the fact that method S10 does not require time consuming initialization of the first and second quantum systems to any particular state prior to each iteration of the method. Consequently, in a given period of time it can be possible to complete more iterations of method S10 than would be possible for another entanglement protocol that required initialization of the quantum systems for each iteration of the protocol. This advantage over protocols that require initialization increases with increased photon losses (since more iterations are needed when the probability of success of each iteration is reduced by photon losses and therefore a protocol that requires initialization of quantum systems in each iteration will spend more time performing the required initializations as photon losses increase and the likelihood of success in any one iteration consequently decreases).

The methods described herein (e.g. method S10) has another advantage in cases where a quantum system that is included in entanglement attempts is part of a broker-client system (e.g. is an electron spin that can act as a broker to a nuclear spin that can serve as a client). For many broker-client systems the act of initializing the broker spin before an entanglement attempt significantly perturbs the state of the client spin. Such perturbation may accelerate decoherence of a quantum state stored in the client spin. Use of entanglement generation methods as described herein, which do not require the quantum systems that are subject to entanglement attempts to be initialized, may better preserve the fidelity of quantum states stored in client systems at the cost of an increase in the probable number of entanglement attempts required to achieve entanglement.

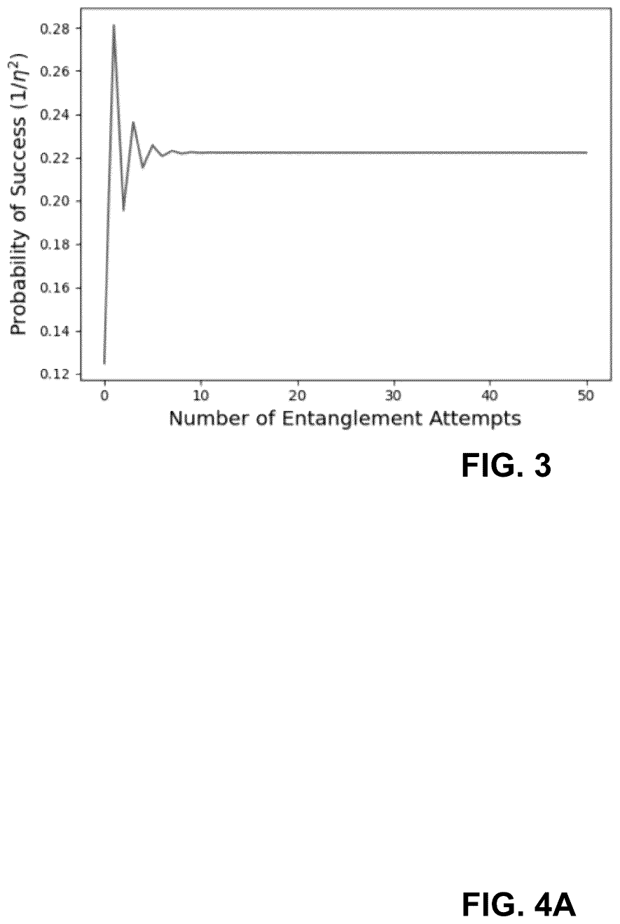

The probability that any individual iteration of method S10 will result in successfully heralded entanglement of the first and second quantum systems varies depending on the combined state of the first and second quantum systems at the start of the iteration. FIG. 3 is a plot which shows probability of success of each iteration of method S10 as a function of a number of iterations of method S10. At the beginning of the first iteration the combined state of the first and second quantum systems corresponds to the density matrix of Eqn. 2. The probability of success asymptotically approaches 0.22η².

FIG. 4 is a graph which shows how probabilities of mixed state components evolve when method S10 is performed starting with the mixed state of Eqn. 2. Curve 41A shows evolution of the probability associated with the component |↓↓ [symbol] [symbol] ↓↓|, curve 41B shows evolution of the probability associated with the component |↑↑ [symbol] [symbol] ↑↑|, and curve 41C shows evolution of the probability associated with each of the components |↓↑ [symbol] [symbol] ↓↑| and |↑↓ [symbol] [symbol] ↑↓|.

### Effect of Branching Ratio

In the examples above it is assumed that excited states reached by the optical transitions of blocks S12 and S16 decay only to one specific level of the ground state (i.e. the branching ratio for transitions from the excited state to ground state levels is 100% to one ground state level and 0% to all other ground state levels—this case corresponds to the branching ratio β having the value β=0). Method S10 can also work for cases where the excited state can decay to more than one ground state level as long as the branching ratio is such that the excited state decays preferentially to one ground state level. For the case where the branching ratio β≠0 application of the π/2 pulses of block S12 maps the state |↓ [symbol] |↓ [symbol] as follows:

$$\vert ↓ 〉 {\to }^{yields} [ ( 1 - β ) \vert ↑ , 1 〉 + \vert ↑ , 0 〉 ]$$

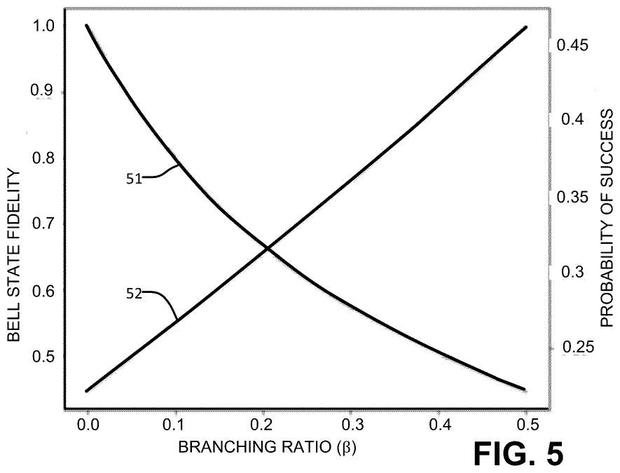

From this mapping it is possible to calculate the fidelity of an entangled state achieved by method S10 as a function of the branching ratio as well as the asymptotic probability of successful heralding as a function of the branching ratio (for the case of iterations of method S10 for which the iteration begins with the first and second quantum systems in a mixed quantum state corresponding to the density matrix of Eqn. 2. Results of these calculations are illustrated by FIG. 5 which includes curve 51 which corresponds to Bell state fidelity as a function of branching ratio and curve 52 which corresponds to probability of success for one iteration as a function of branching ratio.

Example Methods which do not Include Microwave Pulses

As mentioned above, block S15 that applies a microwave π pulse to the first and second quantum systems is optional. In embodiments where block S15 is omitted, the optical transitions used in blocks S12 and S16 may respectively be a cross transition and a vertical transition. A cross transition results in a change in spin of a quantum system that undergoes the transition. For example, a cross transition can be a transition that goes from a first ground state energy level corresponding to a first spin value to an excited state followed by a decay from the excited state to a second ground state energy level corresponding to a second spin value that is different from the first spin value—e.g. a spin up ground state to a spin down excited state followed by a decay to a spin down ground state as would occur with transition 24A followed by a decay on transition 24B or a spin down ground state to a spin up excited state as in optical transition 24D followed by a decay to a spin down grown state via optical transition 24C. A π/2 pulse applied at a wavelength corresponding to an optical cross transition will transform a component of the quantum state of a quantum system that corresponds to the first ground state to components that correspond to a superposition of the first and second ground states.

A vertical transition results in the quantum system being in the same ground spin state after the vertical transition as it was before the vertical transition. For example a vertical transition may involve a transition from a first ground state level corresponding to a particular spin state to an excited state that subsequently decays back to the first ground state level. The vertical transition may involve exciting a quantum system from a ground state energy level to an excited state energy level corresponding to the same spin value as the ground state energy level followed by a decay to the initial ground state level. Exciting a quantum system from energy level 21A to excited energy level 22A via optical transition 24B followed by a decay via optical transition 24B back to ground state energy level 21A is an example of a vertical transition. Another example of a vertical transition is exciting a quantum system from ground state energy level 21B to excited energy level 22B via optical transition 24C followed by a decay back to ground state energy level 21B via optical transition 24C. For example, the optical pulse of block S16 may be modified to match the wavelength of transition 24B instead of the wavelength of transition 24C.

Consider the case wherein this variation of method S10 is applied to a quantum system that is initially in the mixed state of equation (2). The component |↑↑ [symbol] is rejected because application of the π/2 pulse on optical transition 24D in block S12 does not affect the state |↑ [symbol] and so a pair of quantum systems that is initially in the state |↑↑ [symbol] remains in the state |↑↑ [symbol] after application of the π/2 pulse to each of the quantum systems with no photons being emitted. Therefore, the heralding condition at block S14 is not satisfied.

The components |↑↓ [symbol] and |↓↑ [symbol] are also rejected. The optical pulse of block S12 transforms |↑↓ [symbol] to |↑↓,0 [symbol] +|↑↑,1 [symbol] , neglecting normalization. |↑↓,0 [symbol] is rejected for not satisfying the heralding condition of block S14. The π pulse of block S16 at the wavelength of transition 24B does not affect |↑↑ [symbol] which is rejected because the second heralding condition of block S17 is not satisfied. The component |↓↑ [symbol] is rejected for the same reasons.

The component |↓↓ [symbol] is transformed by block S12 to |↓↓,0 [symbol] +|↑↑,2 [symbol] +|↑↓,1 [symbol] +|↓↑,1 [symbol] |↓↓ [symbol] , neglecting normalization. Of these components |↓↓,0 [symbol] and |↑↑,2 [symbol] are rejected for not satisfying the heralding condition of block S14. The optical pulse at block S16 transforms |↑↓ [symbol] to |↑↓ [symbol] and transforms |↓↑ [symbol] to |↓↑ [symbol] . In each case a single photon is emitted for detection at block S17 (so that the heralding conditions for each of blocks S14 and S17 is satisfied).

In some embodiments, iterations of method S10 that omit block S15 alternate between making the optical pulses of blocks S12 and S16 respectively match the wavelengths of optical transitions 24D and 24B and making the optical pulses of blocks S12 and S16 respectively match the wavelengths of optical transitions 24C and 24A.

In some embodiments, some iterations of method S10 include block S15 and some iterations of method S10 omit block S15.

It can be beneficial to include block S15 in method S10. For example, consider the case where one or both of the first and second quantum systems is a broker-client system. For example, an electron spin (e.g. in T centre 20, an unpaired electron of carbon atom 25A) may serve as a broker and a nuclear spin (e.g. in T centre 20, a nucleus of one of atoms 25A, 25B and 26) coupled to the electron spin may serve as a client. For example, the broker may comprise an electron spin of a T centre and the client may comprise a nuclear spin of the T centre.

Application of the microwave π pulse of block S15 may help to prevent or reduce dephasing of the client (e.g. nuclear) spin which may occur as a result of a period in which the broker (e.g. electron) spin is in an unknown state. In particular, the microwave pulse of block S15 can be timed to provide an echo pulse that decouples a significant portion of the phase accumulated by the nuclear spin(s) while the electron spin is in an unknown state.

The phase of a quantum system evolves according to the energy (Hamiltonian) of the quantum system. When the quantum system is in a known state it is possible to track evolution of the phase of the quantum state. Consider the case where a quantum system is a client in a broker-client system (e.g. a nuclear spin in a client broker system that also includes an electron spin). The Hamiltonian of the nuclear spin will generally depend on the quantum state of the electron spin. If the electron is spin up then the quantum state of the nuclear spin may acquire phase at a first rate. If the electron is spin down then the quantum state of the nuclear spin may acquire phase at a second rate different from the first rate.

Where a method as described herein (e.g. method S10) is being performed to entangle the electron with another electron, the electron may be placed in a quantum state that is an unknown superposition of spin up and spin down by the optical pulse of block S12.

The microwave pulse of block S15 may be timed such that the same amount of phase is accumulated by the client (nuclear) spin over the course of one iteration of method S10, regardless of the makeup of the spin state of the broker (electron) at those times when the spin state of the electron is not known. Since the microwave π-pulse flips the spin states of the electron (e.g. the superposition a|↓ [symbol] +b|↑ [symbol] becomes a|↑ [symbol] +b|↓ [symbol] after the microwave π-pulse). The microwave π-pulse can therefore be applied at a time chosen so that the phase acquired over the entire time that the electron is in the unknown superposition of spin up and spin down (including the times before and after the microwave π-pulse, the acquired phase does not depend on the values of a and b. For example, where the Hamiltonian for the client (nuclear spin) has the form (or can be closely enough approximated by): P_{↑}R_{↑}+P_{↓}R_{↓} where P_{↑} and P_{↓} are respectively the probabilities that measurement of the broker (electron) will find the broker to be spin up and spin down and R_{↑} and R_{↓} are constants then it can be shown that the total phase acquired by the client over a time T made up of a first period T₁ before the microwave π-pulse (during which P_{↑}=a and P_{↓}=b) and a second period T₂ after the microwave π-pulse (during which P_{↑}=b and P_{↓}=a) is independent of the values of a and b when T₁=T₂.

An additional benefit of including the microwave π-pulse is that inclusion of the microwave π-pulse facilitates the use of the same wavelengths for optical pulses in blocks S12 and S16 in each iteration of method S10.

### Other Example Methods and Variations

In the example embodiment discussed above which exploits optical transitions 24D and 24C at blocks S12 and S16 respectively, it is the density matrix component |↓↓ [symbol] [symbol] ↓↓| that can lead to successful heralding of entanglement in the Bell state |↑↓ [symbol] ∓|↓↑ [symbol] . If optical transitions 24B and 24A are exploited in place of optical transitions 24D and 34C instead, the density matrix component |↓↓ [symbol] [symbol] ↓↓| is the component that can lead to successful heralding of entanglement because optical transitions 24B and 24A map the quantum states of quantum systems 11 in the same way as optical transitions 24D and 24C.

Method S10 describes applying optical pulses or optical pulses and microwave pulses to manipulate quantum states of quantum systems to be entangled. As is known to those of skill in the art, a desired rotation in the Bloch sphere representation of a quantum state (e.g. a rotation of π or π/2) may be implemented by one pulse having a magnitude and duration selected to achieve the desired rotation or a series of pulses that have magnitudes and durations which collectively achieve the desired rotation. Furthermore, pulses are not necessarily rectangular pulses but may be shaped in various ways as known in the art. Consequently, unless otherwise stated, reference to a π/2 pulse or a π pulse herein includes both the case where the pulse is implemented by a single pulse and the case where the pulse is implemented by a series of pulses which cause the desired rotation in the Bloch sphere of π/2 or π respectively.

Those of skill in the art who read and understand the present disclosure will understand that the described methods can succeed even if pulses used to manipulate quantum states of quantum systems (e.g. the optical π/2 pulse of block S12, the microwave π pulse of block S15 or the optical π pulses of block S16) are not configured to precisely achieve the desired rotation of the quantum state in the Bloch sphere. For example, method S10 may succeed in generating entanglement if the optical pulse of block S12 yields a rotation that is less than or more than π/2 radians, although too much departure from the stated rotations can result in an increase of the expected number of entanglement attempts to achieve entanglement of a pair of quantum systems. In some embodiments the pulses are configured to produce approximately or about the stated rotations. In some embodiments the pulses are configured to yield rotations that are within 5%, 2%, 1% or 0.6% of the stated rotations.

For quantum systems of some types, quantum states of the quantum systems may be manipulated by modalities other than optical and/or microwave pulses. When the methods described herein are applied to such quantum systems it is an option to manipulate quantum states of the quantum systems as described herein using such other modalities. For example, spins in some colour centres may be caused to undergo transitions by applying oscillating strain to the substrate in which the colour centre is located. In such cases a desired Bloch sphere rotation of the quantum state of a quantum system (e.g. of π radians) might be achieved by delivering an oscillating strain having an appropriate frequency, magnitude and duration at the location of the colour centre of which the quantum system forms a part.

The present technology may be applied to generate entanglement of quantum systems of diverse types wherein a quantum state of the quantum system can be transduced into a photonic state. Photonic states may have wavelengths ranging from microwave wavelengths to ultraviolet. Some embodiments use quantum systems which serve as spin-photon interfaces. A spin-photon interface that emits spin-entangled photons having wavelengths in telecom bands (e.g. 1260 nm to 1625 nm) are particularly advantageous. The electron spin of a T centre is an example of a spin-photon interface that can be caused to emit spin-entangled photons having telecom wavelengths. With single photon microwave detectors or microwave to optical transducers the present technology may be applied to generate quantum entanglement of quantum systems that can be made to emit microwave photons that have photon states that are entangled with photon states of the quantum systems. For example the methods described herein may be applied to entangle quantum states of superconducting qubits of types which can emit entangled microwave photons.

### Extension to Adaptive Methods

A mechanism that adapts method S10 based on feedback in the form of alterations of individual iterations of method S10 based on measurement results from one or more previous iterations of method S10 may, for example be implemented using a data processor that receives measurement results from blocks S14 and S17, performs classical logic operations and/or lookups based on the measurement results, and generates control signals that alter the operation of a subsequent iteration of method S10 based on results of the classical logic operations and/or lookups.

For example, in some embodiments, information learned about the combined state of the first and second quantum systems from a pattern of photon detections (or a lack of photon detections) in blocks S14 and/or S17 in a failed iteration of method S10 (i.e. an iteration that does not result in heralded entanglement of the first and second quantum systems) may be used to improve the probability of success of a subsequent iteration of method S10. For example, if the optional microwave TT-pulse of block S15 is not applied during an iteration of method S10 then the detection of two photons in either of blocks S14 and S17 indicates that the state of the first and second quantum systems at the end of the iteration is |↓↓ [symbol] [symbol] ↓↓∥↑↑ [symbol] [symbol] ↑↑∥↑↑ [symbol] [symbol] ↑↑|. In this case one could flip the spins of the first and second quantum systems (e.g. by applying a microwave π-pulse to each spin). The next iteration of method S10 would then have a probability of success of η²/2.

### Example Apparatus

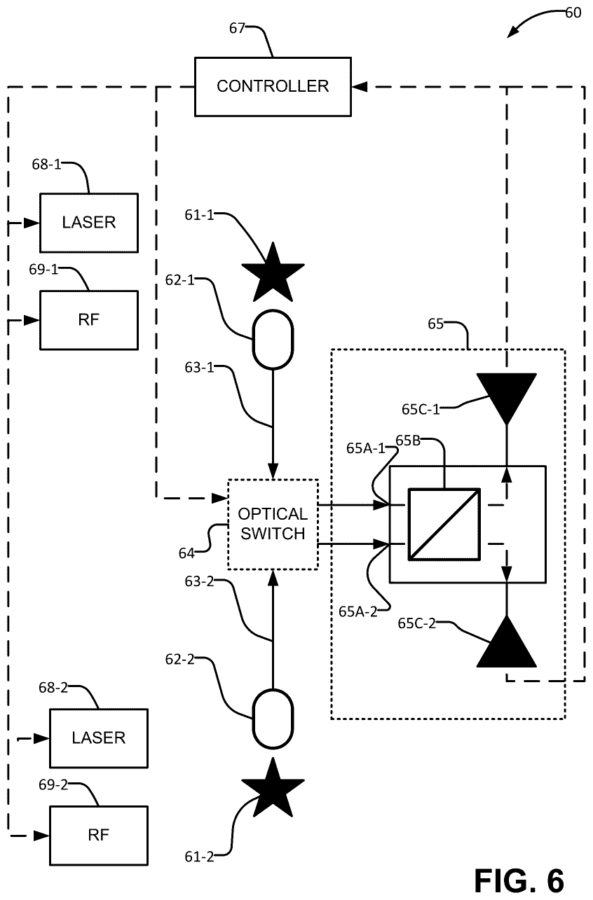

Method S10 is not limited to use with specific types quantum systems or specific constructions of apparatus. FIG. 6 schematically illustrates an example apparatus 60 that may be used to implement method S10. Apparatus 60 includes first and second quantum systems 61-1 and 61-2 (generally and collectively quantum systems 61) that may be entangled by the application of the steps of method S10 or any of its variations as described herein.

Quantum systems 61-1 and 61-2 are respectively coupled to optical channels 63-1 and 63-2 (generally and collectively optical channels 63) by optical couplers 62-1 and 62-2 (generally and collectively optical couplers 62). Optical couplers 62 serve to couple any photons which are generated as a result of optical transitions of quantum systems 61 into the respective optical channels 63.

Optical couplers 62 may, for example, comprise optical resonators (e.g. resonant cavities which may comprise photonic cavities for example). In some embodiments optical couplers 62 are configured to reduce the lifetime of the excited states of quantum systems 61. For example, optical couplers 62 may be resonant at wavelength(s) corresponding to decay of the excited state such that the lifetime of the excited state is reduced by Purcell enhancement. For example, optical couplers 62 may be resonant at wavelengths corresponding to optical transition 15A and/or 15B of FIG. 1A or 24A and/or 24C of FIG. 2.

Optical channels 63 may comprise any suitable waveguides (e.g. optical fibers, integrated optical waveguides, free space transmission, etc.). Optical channels 63-1 and 63-2 respectively route photons originating from quantum systems 61-1 and 61-2 to first and second optical inputs 65A-1, 65A-2 of a Bell state analyzer (BSA) 65.

Apparatus 60 includes an optical switching network 64 which is selectively configurable to optically connect any of plural pairs of different quantum systems 61 (not shown in FIG. 6) to the optical inputs 65A-1 and 65A-2 of BSA 65.

BSA 65 includes an interference device 65B and photon detectors 65C-1 and 65C-2. Interference device 65B allows photon states received at inputs 65A-1 and 65A-2 substantially simultaneously to interfere such that a photon state received at either one of inputs 65A-1 and 65A-2 may result in a photon detection event at either one of photon detectors 65C-1 and 65C-2. Interference device 65 may, for example comprise a suitable beam splitter.

A controller 67 is connected to control apparatus 60. Controller 67 may, for example, be configured to control apparatus 60 to generate entanglement of quantum systems 61-1 and 61-2 by method S10.

Controller 67 may comprise specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method S10 or any of the variations of method S10 as explained in detail herein and/or combinations of two or more of these.

Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Controller 67 may be centralized or distributed. Where processing is distributed, information including software and/or data may be kept centrally or distributed. Such information may be exchanged between different functional units by way of a suitable data communication network.

In some embodiments, controller 67 comprises or is connected to access a program product. The program product may comprise any non-transitory medium which carries a set of computer-readable instructions which, when executed by a data processor, cause the data processor to execute a method of the invention and/or to configure configurable hardware to perform all or a part of a method according to the invention.

Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

Controller 67 is connected to control optical switching network 64, for example to provide optical connectivity between each of quantum systems 61-1 and 61-2 (or another pair of quantum systems 61) to respective ones of inputs 55A-1 and 65A-2 of BSA 65. In cases where quantum systems 61-1 and 61-1 have a dedicated BSA 65, optical switching network 64 may be omitted.

Controller 67 is also connected to control one or more optical sources that are controllable to deliver optical π/2 pulses and optical π pulses to quantum systems 61-1 and 61-2. In apparatus 60, controller 67 is connected to control laser systems 68-1 and 68-2 which are respectively operable to deliver laser light to quantum systems 61-1 and 61-2. Laser systems 68-1 and 68-2 may be tuned to emit laser light having a wavelength that corresponds to an optical transition of the respective quantum system 61-1 or 61-2. In some embodiments laser systems 68-1 and 68-2 are selectively controllable to emit laser light that has a wavelength matching any one of plural optical transitions of the respective quantum system 61-1 or 61-2.

In some embodiments apparatus 60 comprises one or more tuning mechanisms operative to tune wavelengths of optical transitions of one or more of quantum systems 61 and/or to tune one or more of optical couplers 62. For example, the wavelength of a transition in a quantum system 61 by altering an electric field or magnetic field at the location of the quantum system 61 and/or by altering strain in a substrate in or on which the quantum system 61 is located. The response of an optical resonator to light having a particular wavelength may be adjusted by applying an electric field at the location of the optical resonator, altering physical dimensions of the optical resonator and/or altering a refractive index of the optical resonator. Controller 67 may, for example, operate such tuning mechanisms to match wavelengths of photons emitted by quantum system 61-1 and quantum system 61-2 and to optimize coupling of each of quantum systems 61-1 or 61-2 to the respective optical channel 63-1 or 63-2.

Controller 67 is also connected to receive outputs from photon detectors 65C-1 and 65C-2 of BSA 65. In response to such outputs, controller 67 may perform one or more of: determine whether heralding conditions for entanglement of quantum systems 61-1 and 61-2 are satisfied in a current iteration of method S10; if the heralding conditions are not satisfied, determine a feedback action to increase the probability of success of a subsequent iteration of method S10 and apply the feedback action.

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

### INTERPRETATION OF TERMS

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A method for causing quantum entanglement of a first quantum system and a second quantum system, each of the first and second quantum systems having first and second non-degenerate ground states, an excited state, a first optical transition from the first ground state to the excited state and a second optical transition from the excited state to the second ground state, the method comprising:
(a) applying a first optical pulse to each of the first and second quantum systems, the first optical pulses having a wavelength matching the first optical transition;
(b) in a first window following application of the first optical pulses, monitoring to detect photons resulting from application of the first optical pulses to the first and second quantum systems;
(c) applying a second optical pulse to each of the first and second quantum systems, the second optical pulses having a wavelength matching the second optical transition;
(d) in a second window following application of the second optical pulses, monitoring to detect photons resulting from application of the second optical pulses to the first and second quantum systems; and
(e) determining whether or not the first and second quantum systems are entangled based on a first heralding condition for any photons detected in the first window and a second heralding condition for any photons detected in the second window; and
(f) if the first and second heralding conditions are not both satisfied, repeating steps (a) through (e) without first initializing either of the first and second quantum systems.

2. The method according to claim 1 wherein, each of the first and second quantum systems are initially in a mixed state, and the first optical pulse is applied to the first and second quantum system in the mixed state.

3. The method according to claim 2 wherein, the heralding conditions reject all but one component of the mixed state.

4. The method according to claim 1 comprising applying a microwave pulse to each of the first and second quantum systems prior to performing steps (c) to (e).

5. The method according to claim 4 wherein, a client quantum system is associated with at least one of the first and second quantum systems.

6. The method according to claim 5 wherein, a timing of the microwave pulse is selected to decouple a phase accumulated by the client quantum system due to a quantum state of the at least one of the first and second quantum systems.

7. The method according to claim 1 wherein, the first optical pulses are optical π/2 pulses.

8. The method according to claim 6 wherein, the second optical pulses are optical π pulses.

9. The method according to claim 1 wherein, the second optical pulses are optical π pulses.

10. The method according to claim 1 wherein, the first optical transition is a cross transition.

11. The method according to claim 10 wherein, the second optical transition is a vertical transition.

12. The method according to claim 1 wherein, each of the first and second quantum systems is an electron spin associated with a luminescence centre.

13. The method according to claim 12 wherein the luminescence centre is a T centre.

14. The method according to claim 12 comprising altering one or more iterations of the method based on measurement results obtained in one or more prior iterations of the method.

15. The method according to claim 14 comprising in response to detecting two photons in either of the first window and the second window of one iteration of the method, altering the next iteration of the method by flipping the electron spins prior to performing step (a) of the next iteration of the method.

16. The method according to claim 1 comprising altering one or more iterations of the method based on measurement results obtained in one or more prior iterations of the method.

17. The method according to claim 16 comprising in response to detecting two photons in either of the first window and the second window of one iteration of the method, altering the next iteration of the method by flipping the electron spins prior to performing step (a) of the next iteration of the method.

18. A non-transitory, computer-readable medium comprising executable instructions stored thereon, that when executed on a processor, perform the method according to claim 17.

19. A non-transitory, computer-readable medium comprising executable instructions stored thereon, that when executed on a processor, perform the method according to claim 1.
